(19) United States
(12) Patent Application Publication
(10) Pub. No.: US 2025/0371366 A1
(43) Pub. Date: Dec. 4, 2025

(54) MULTI-AGENT REINFORCEMENT LEARNING-BASED OPTIMAL ENERGY SENSING THRESHOLD CONTROL METHOD AND DEVICE IN DISTRIBUTED COGNITIVE RADIO NETWORKS

(71) Applicant: CHUNG ANG UNIVERSITY INDUSTRY ACADEMIC COOPERATION FOUNDATION, Seoul (KR)

(72) Inventors: Sung Rae CHO, Seongnam-si (KR); Thi Thu Hien PHAM, Seoul (KR); Dong Hyun LEE, Seoul (KR); Dong Hyeon HUR, Seoul (KR)

(21) Appl. No.: 19/044,330

(22) Filed: Feb. 3, 2025

(30) Foreign Application Priority Data
May 29, 2024 (KR) 10-2024-0070155

(51) Int. Cl. G06N 3/092

(52) U.S. Cl. CPC G06N 3/092

(57) ABSTRACT

A multi-agent reinforcement learning-based optimal energy sensing threshold control method in distributed cognitive radio networks includes: (a) constructing a state space for a network environment including a plurality of primary terminals and a plurality of secondary terminals, the state space including each state about whether the primary terminals are occupied; (b) selecting an action in accordance with a policy by applying partial observation of each secondary terminal to a reinforcement learning-based actor-critic network model by means of an agent, and calculating a reward on the basis of a sensing result of the primary terminals on the basis of the selected action in the environment, the action being a sensing threshold; (c) storing the partial observation, the selected action, the reward, and next observation into a replay buffer as experiences; and (d) updating the actor-critic network model on the basis of the experiences stored in the replay buffer.

### CROSS-REFERENCE TO RELATED APPLICATION

This application claims the benefit of priority under 35 U.S.C. § 119(a) to Korean Patent Application No. 10-2024-0070155, filed on May 29, 2024, the entire contents of which is incorporated herein by reference.

### BACKGROUND

### (a) Technical Field

The present disclosure relates to multi-agent reinforcement learning-based optimal energy sensing threshold control method and device in distributed cognitive radio networks.

### (b) Background Art

As the number of network devices increases, the demand for additional wireless frequency spectrum bands is growing and the necessity of cognitive radio network (hereafter referred to as CRN) technology is emerging to address the shortage of wireless resources.

Through CRN, secondary users (hereafter referred to as SU) can opportunistically access spectrum bands authorized by primary users (hereafter referred to as PU).

To use the existing CRN method, devices must accurately detect and utilize vacant spectrum bands while avoiding interference. However, this poses a challenging issue due to the dynamic and uncertain wireless environment, including factors such as multi-path fading, shadowing, and receiver uncertainty.

Cooperative spectrum sensing (hereafter referred to as CSS) consists of two systems of a centralized type and distributed type. The centralized CSS method involves operation costs related to FC and potential bottleneck problems.

### SUMMARY OF THE DISCLOSURE

The present disclosure is to provide multi-agent reinforcement learning-based optimal energy sensing threshold control method and device in distributed cognitive radio networks.

Further, the present disclosure is to provide multi-agent reinforcement learning-based optimal energy sensing threshold control method and device in distributed cognitive radio networks, the method and device being capable of determine an optimal sensing threshold that can maximize a detection probability of a primary terminal and minimize a false alarm probability.

According to an embodiment of the present disclosure, there is provided a multi-agent reinforcement learning-based optimal energy sensing threshold control method in distributed cognitive radio networks.

According to an embodiment of the present disclosure, there may be provided a multi-agent reinforcement learning-based optimal energy sensing threshold control method in distributed cognitive radio networks, the method including: (a) constructing a state space for a network environment including a plurality of primary terminals and a plurality of secondary terminals, the state space including each state about whether the primary terminals are occupied; (b) selecting an action in accordance with a policy by applying partial observation of each secondary terminal to a reinforcement learning-based actor-critic network model by means of an agent, and calculating a reward on the basis of a sensing result of the primary terminals on the basis of the selected action in the environment, the action being a sensing threshold; (c) storing the partial observation, the selected action, the reward, and next observation into a replay buffer as experiences; and (d) updating the actor-critic network model on the basis of the experiences stored in the replay buffer.

The replay buffer may also store experiences of other agents in a training step, and, in the step (d), each agent may train the actor-critic network model of each agent in a centralized manner by sharing the experiences of other agents; and the step (d), in an execution step, each agent may update the actor-critic network model of each agent using only a local experience of each agent.

The policy may determine a sensing threshold that maximizes a probability of correctly detecting the primary terminals and minimizes an accumulated false alarm probability up to a time step t, and the policy is formulated into the following equation,

$${max}_{{ϵ}_{t} = \{ {ϵ}_{t}^{i} ( {c}_{t}^{i} , {s}_{t}^{i} ) \}} {\sum }_{t \geq 0} {{\sum }^{M}}_{i = 1} {P}_{d}^{i} ( t ) + ( 1 - {P}_{f}^{i} ( t ) )$$

$$s . t . {ϵ}_{t}^{i} ( {c}_{t}^{i} , {s}_{t}^{i} ) \geq 0 ,$$

$$∀ {c}_{t}^{i} ∈ [ 0 , … , K - 1 ] , {s}_{t}^{i} ∈ [ 0 , … , L - 1 ]$$

wherein,

$${ϵ}_{t}^{i} ( {c}_{t}^{i} , {s}_{t}^{i} )$$

represents a detection threshold for specific channel

$${c}_{t}^{i}$$

and sector

$${s}_{t}^{i}$$

at a time step t selected by an i-th secondary terminal,

$${c}_{t}^{i}$$

represents an orthogonal channel owned by a primary terminal,

$${s}_{t}^{i}$$

represents a sector of the i-th secondary terminal, K represents the number of orthogonal channels, L represents the number of sectors,

$${P}_{d}^{i} ( t )$$

represents an accumulated detection probability of a primary terminal up to the time step t,

$${P}_{f}^{i} ( t )$$

represents an accumulated false alarm probability up to the time step t, and M represents an index of a secondary terminal.

The reward gives zero (0) when a detection result of a primary terminal based on the selected action in the environment and an actual state are the same, and gives a penalty when the detection result of the primary terminal based on the selected action in the environment and the actual state are different; and the actual state is any one of channel occupation or non-occupation of the primary channel.

According to an embodiment, there are provided a device and a system that can control a multi-agent reinforcement learning-based optimal energy sensing threshold in distributed cognitive radio networks.

According to an embodiment of the present disclosure, there may be provided a computing device including: a memory storing at least one command; and a processor executing the commands stored in the memory, wherein the commands executed by the processor respectively perform: (a) constructing a state space for a network environment including a plurality of primary terminals and a plurality of secondary terminals, the state space including each state about whether the primary terminals are occupied; (b) executing each agent for each secondary terminal, selecting an action in accordance with a policy by applying partial observation of each secondary terminal to a reinforcement learning-based actor-critic network model by means of an agent, and calculating a reward on the basis of a sensing result of the primary terminals on the basis of the selected action in the environment, the action being a sensing threshold; (c) storing the partial observation, the selected action, the reward, and next observation of each agent into a replay buffer as experiences; and (d) updating the actor-critic network model of each agent on the basis of the experiences stored in the replay buffer.

According to another aspect of the present disclosure, there may be provided a system including: a plurality of primary terminals; and a plurality of secondary terminals, wherein the plurality of secondary terminals each includes: constructing a state space for a network environment including a plurality of primary terminals and a plurality of secondary terminals, the state space including each state about whether the primary terminals are occupied; selecting an action in accordance with a policy by applying partial observation of each secondary terminal to a reinforcement learning-based actor-critic network model by means of an agent, and calculating a reward on the basis of a sensing result of the primary terminals on the basis of the selected action in the environment, the action being a sensing threshold; storing the partial observation, the selected action, the reward, and next observation into a replay buffer as experiences; and updating the actor-critic network model on the basis of the experiences stored in the replay buffer.

Multi-agent reinforcement learning-based optimal energy sensing threshold control method and device in distributed cognitive radio networks according to an embodiment of the present disclosure are provided, thereby determining an optimal sensing threshold that can maximize a detection probability of primary terminals and can minimize a false alarm probability.

### BRIEF DESCRIPTION OF DRAWINGS

FIG. 1 is a diagram schematically showing a distributed cognitive radio network system according to an embodiment of the present disclosure.

FIG. 2 is a flowchart illustrating a multi-agent reinforcement learning-based optimal energy sensing threshold control method in distributed cognitive radio networks according to an embodiment of the present disclosure.

FIG. 3 is a diagram showing a pseudocode for FIG. 2.

FIG. 4 is a diagram showing a system simulation environment according to an embodiment of the present disclosure.

FIG. 5 is a diagram showing simulation parameters according to an embodiment of the present disclosure.

FIG. 6 is a diagram showing convergence results at different detection times according to an embodiment of the present disclosure.

FIG. 7 is a diagram comparing convergence results of energy sensing threshold control method according to the related art and an embodiment of the present disclosure.

FIG. 8 is a diagram showing the result of comparing detection probabilities and false alarm probabilities according to the related art and an embodiment of the present disclosure.

FIG. 9 is a block diagram schematically showing the internal configuration of a computing device according to an embodiment of the present disclosure.

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “˜ unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

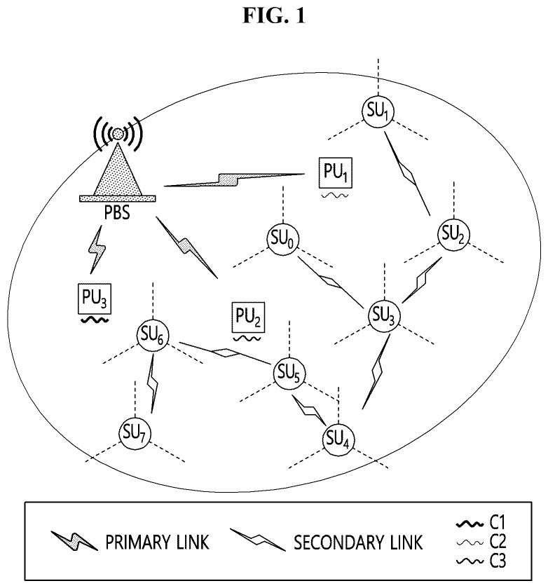

FIG. 1 is a diagram schematically showing a distributed cognitive radio network system according to an embodiment of the present disclosure.

As shown in FIG. 1, it is assumed that a distributed cognitive radio network system according to an embodiment of the present disclosure includes a main network and an auxiliary ad hoc network.

The main network may be a network between a primary base station (PBS) and a plurality of PUs. In this case, it is assumed that the number of PUs is U.

The auxiliary network may be an ad hoc network formed by M SUs.

According to an embodiment of the present disclosure, it is assumed that the PUs and SUs are static in a network.

In traditional centralized cognitive networks, a coordinator node is needed to perform the role of making decision by fusing information from other nodes. However, in an embodiment of the present disclosure, it is assumed that after the SUs have sufficient time to collaborate and learn about an environment, it can operate equally in a distributed environment.

It is assumed that the PUs, as shown in FIG. 1, are equipped with an omnidirectional antenna. Further, it is assumed that the PUs periodically broadcast a pilot signal, as in Digital Video Broadcasting-Terrestrial (DVB-T) of the IEEE 802.22, a standard for wireless regional area networks (WRAN) using a white space band that is a TV frequency band.

Further, it is assumed that the PUs own a total of K orthogonal channels. That is, it is assumed that the PUs have the highest priority in using the corresponding orthogonal channels, and since the SUs are unlicensed users, they have to wait until the PUs release the channels.

The SUs are nodes that do not have permission for the corresponding spectrums of wireless resources, and have to find and use a spectrum that is not being used by the PUs. The SUs that do not have spectrum usage priority for wireless resources, as described above, have to yield the spectrum usage to a PU if the PU tries to use the spectrum while the SUs transmit data. Accordingly, the SUs have to periodically sense spectrums.

It is assumed that all of the SUs are equipped with a directional antenna, each SU having L sectors, and they do not overlap ideally. The SUs can sense free channels and transmit data using the directional antennas. Further, with the help of the directional antennas, the SUs can use the same channel as the PUs without causing interference to the primary network.

On the other hand, the PUs are equipped with a traditional omnidirectional antenna for communication. In an embodiment of the present disclosure, it is assumed that the network model of the system is Omn-Dir-CRN.

In an embodiment of the present disclosure, it is assumed that all of the SUs use an energy detection (hereafter referred to as ED)-based spectrum sensing method to sense presence of the PUs and determine whether a specific channel is occupied by the PUs.

Since ED does not require historical information, it is an inconsistent and widely used detection method and is typically performed with a general binary hypothesis test.

$${H}_{1}^{i} ( {c}^{i} , {s}^{i} ) and {H}_{0}^{i} ( {c}^{i} , {s}^{i} )$$

relatively represent presence and absence of a PU under the observation of SUᵢ when an i-th Su SUᵢ senses a channel cⁱ and a sector sⁱ.

Assuming that yⁱ(n|cⁱ, sⁱ) is a signal received from the i-th SU SUᵢ, it can be expressed as in Equation 1.

$${y}^{i} ( n \vert {c}^{i} , {s}^{i} ) = \{ \begin{matrix}{h}^{i} s ( n ) + u ( n ) , & {H}_{1}^{i} ( {c}^{i} , {s}^{i} ) , \\ u ( n ) , & {H}_{0}^{i} ( {c}^{i} , {s}^{i} ) ,\end{matrix} \qquad [ Equation 1 ]$$

wherein, hⁱ represents a channel gain, s(n) represents a signal of a PU, and u(n) represents an additive white Gaussian noise (AWGN) with a mean of 0 (zero).

A detection process can start with yⁱ(n|cⁱ, sⁱ) passing through an ideal band-pass filter to limit the noise bandwidth. The output, after being squared and integrated over an observation time interval, can give a final test static for the SUᵢ as in Equation 2.

$${λ}^{i} ( {c}^{i} , {s}^{i} ) = \frac{1}{N} {\sum }_{n = 1}^{N} {\vert {y}^{i} ( n \vert {c}^{i} , {s}^{i} ) \vert}^{2} \qquad [ Equation 2 ]$$

wherein, N represents the number of received samples. The test statistic can be compared with a detection threshold ϵⁱ to determine presence or absence of a PU.

This can be expressed mathematically as in Equation 3.

$${λ}^{i} ( {c}^{i} , {s}^{i} ) \begin{matrix}H 1 \\ ⋛ \\ H 0\end{matrix} {ϵ}^{i} ( {c}^{i} , {s}^{i} ) \qquad [ Equation 3 ]$$

The occupation state of a PU for a channel is composed of a Markov chain model in two states of busy(1) and idle(0). In this case, busy(1) represents an occupied state and idle(0) represents an unoccupied state, that is, an idle state. It is assumed that α and 1−α are probabilities of transitioning from a busy state to a busy state or from a busy state to an idle state, respectively. Further, it is assumed that probabilities of transitioning from an idle state to an idle state or from an idle state to a busy state are 1 and 1−β, respectively.

The probability of transitioning to an occupied state is the same for all channel and can be expressed as in Equation 4.

$$\begin{matrix}{P}_{trans} = [ \begin{matrix}idle \to idle & idle \to busy \\ busy \to idle & busy \to busy\end{matrix} ] \\ = [ \begin{matrix}β & 1 - β \\ 1 - α & α\end{matrix} ]\end{matrix} . \qquad [ Equation 4 ]$$

The time frame structure of an US does not require time for control in comparison to other centralized system because SUs are individually operated.

Each active period of the SUs consists of two main parts of sensing and transmitting, and T and τ represent the length of an active period and a sensing period. These parameters can be maintained at a constant level at all of the SUs in the system.

The detection probability of a PU according to an ED method can be expressed as in Equation 5. In this case, the detection probability of a PU means the probability that SUᵢ detects a PU regardless of cⁱ and sⁱ.

$${P}_{d}^{i} = P ( {λ}^{i} > {ϵ}^{i} \vert {H}_{1} ) = {Q}_{\frac{N}{2}} ( \sqrt{2 {λ}^{i}} , \sqrt{2 {ϵ}^{i}} ) \qquad [ Equation 5 ]$$

wherein,

$${Q}_{\frac{N}{2}} ( … )$$

represents a generalized Marcum Q function.

On the other hand, a false alarm probability for a PU of SUᵢ can be calculated as in Equation 6.

$${P}_{f}^{i} = P ( {λ}^{i} > {ϵ}^{i} \vert {H}_{0} ) = \frac{Γ ( \frac{N}{2} , \frac{{ϵ}^{i}}{2} )}{Γ ( \frac{N}{2} )} \qquad [ Equation 6 ]$$

wherein, Γ(.) and Γ(., .) represent a gamma function and an incomplete gamma function, respectively.

Equation 5 and Equation 6 are widely used under the assumption that a detection threshold ϵⁱ is maintained for a predetermined period.

However, in an embodiment of the present disclosure, it is assumed that the detection threshold ϵⁱ is a time-varying variable. That is, detection threshold ϵⁱ is probabilistic and can vary over time. In this case, the detection probability up to time point tₙ can be expressed as in Equation 7.

$${P}_{d}^{i} ( {t}_{n} ) = \frac{\sum \begin{matrix}{t}_{n} \\ t = 0\end{matrix} {1}_{\{ {λ}_{t}^{i} > {ϵ}_{t}^{i} \vert {c}_{t}^{i} , {s}_{t}^{i} \}} ( {e}_{t} )}{\sum \begin{matrix}{t}_{n} \\ t = 0\end{matrix} {1}_{\{ {H}_{1}^{i} ( {c}_{t}^{i} , {s}_{t}^{i} ) \}} ( {e}_{t} )} \qquad [ Equation 7 ]$$

wherein, 1_{(.)}(eₜ) represents an indicator that indicates that an event has occurred. Further, the false alarm probability up to time point tₙ can be calculated as in Equation 8.

$${P}_{f}^{i} ( {t}_{n} ) = \frac{\sum \begin{matrix}{t}_{n} \\ t = 0\end{matrix} {1}_{\{ {λ}_{t}^{i} > {ϵ}_{t}^{i} \vert {c}_{t}^{i} , {s}_{t}^{i} \}} ( {e}_{t} )}{\sum \begin{matrix}{t}_{n} \\ t = 0\end{matrix} {1}_{\{ {H}_{0}^{i} ( {c}_{t}^{i} , {s}_{t}^{i} ) \}} ( {e}_{t} )} \qquad [ Equation 8 ]$$

An object of the present disclosure is to determine an optimal energy detection threshold for a channel-sector pair at each time step for all SUs. That is, an object of the present disclosure may be to maximize the probability of correctly sensing presence of a PU while minimizing a false alarm probability that are two main performance factors of the sensing method by finding optimal variables.

Accordingly, the problem at a specific time step t can be formulated as in Equation 9.

$$\begin{matrix}\begin{matrix}{max}_{{ϵ}_{t} = \{ {ϵ}_{t}^{i} ( {c}_{t}^{i} , {s}_{t}^{i} ) \}} {\sum }_{t \geq 0} {\sum }_{i = 1}^{M} {P}_{d}^{i} ( t ) + ( 1 - {P}_{f}^{i} ( t ) ) \\ \begin{matrix}s . t . & {ϵ}_{t}^{i} ( {c}_{t}^{i} , {s}_{t}^{i} ) \geq 0 ,\end{matrix}\end{matrix} \\ ∀ {c}_{t}^{i} ∈ [ 0 , ... , K - 1 ] , {s}_{t}^{i} ∈ [ 0 , ... , L - 1 ]\end{matrix} \qquad [ Equation 9 ]$$

wherein,

$${ϵ}_{t}^{i} ( {c}_{t}^{i} , {s}_{t}^{i} )$$

represents a detection threshold for a specific channel

$${c}_{t}^{i}$$

and a sector

$${s}_{t}^{i}$$

at a time interval t selected by SUᵢ. The problem in Equation 9 is a probabilistic sequential optimization problem, which is an NP-hard problem, so it will be reformulated as a Markov decision process (MDP) to solve it. Hereafter, this is described in more detail.

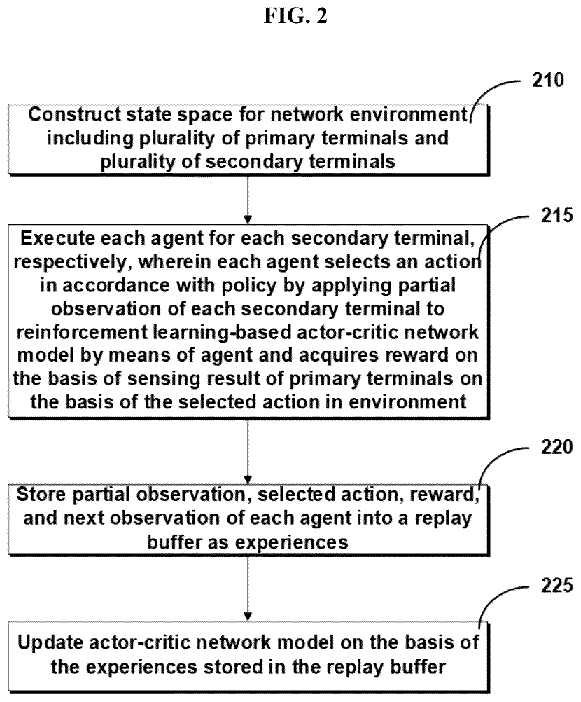

FIG. 2 is a flowchart illustrating a multi-agent reinforcement learning-based optimal energy sensing threshold control method in distributed cognitive radio networks according to an embodiment of the present disclosure. It is assumed that each of steps that are performed hereafter is performed by a computing device. In this case, the computing device may be a server, may be an each SU, or may also be a partial device included in each SU.

In step S210, a computing device 200 constructs a state space for a network environment that includes a plurality of primary terminals and a plurality of secondary terminals.

In this case, the environment may be the distributed cognitive radio network system environment described with reference to FIG. 1.

That is a diagram schematically showing the distributed cognitive radio network system.

As shown in FIG. 1, it is assumed that a distributed cognitive radio network system according to an embodiment of the present disclosure includes a main network and an auxiliary ad hoc network.

Since each SU has no prior knowledge about the environment and the detection information of other SUs, all decisions made by the SU must be based on corresponding local knowledge. Accordingly, a problem can be converted into Dec-POMDP that can be defined using a tuple of ( [symbol] , [symbol] , {Oⁱ [symbol] , { [symbol] ⁱ [symbol] , {rⁱ [symbol] , [symbol] , {yⁱ [symbol] , γ). Wherein, [symbol] ={1, . . . , M} represents a set of all agents, [symbol] is a set showing the actual state of an environment, [symbol] ⁱ represents a partial observation space admitted by an agent i, and [symbol] ⁱ represents an action space of an i-th agent. Further, [symbol] = [symbol] ¹× . . . × [symbol] ^{M} represents action sets of all agents and rⁱ(s, a, s′): [symbol] × [symbol] × [symbol] → [symbol] represents a reward that an agent i receives from an environment when taking action ‘a’ from a state S to a new state S′. Further, [symbol] (s′|s, a): [symbol] × [symbol] → [symbol] represents a transition probability to a new state when known state and action are given, yⁱ: [symbol] →Oᵢ represents an observation channel mapping the actual state of an environment to observation of an agent, and γ∈[0,1) represents a discount factor. The object of all agents is to find an optimal policy μⁱ: [symbol] ⁱ→ [symbol] ⁱ that maximizes an expected long-term discounted reward.

Four main elements of Dec-POMDP are the actual state of an environment, partial observation for an SU, an action space of an SU, and a reward space.

According to an embodiment of the present disclosure, the state space may be configured as a state about whether each PU occupies a channel. For example, the state at each time step t can be defined as

$${s}_{t} = {[ {B}_{t}^{i} ]}_{i ∈ ℳ} .$$

In this case,

$${B}_{t}^{i} = {[ {B}_{t}^{i , k} ]}_{k ∈ 0 , ... , K - 1}^{T}$$

represents the state about whether a PU occupies a channel,

$${B}_{t}^{i , k} = {[ {b}_{t}^{i , k , l} ]}_{l ∈ 0 , ... , L - 1}$$

is a K×L matrix in which,

$${b}_{t}^{i , k , l} = 1$$

represents that there is at least one PU using a k-th channel and is positioned in a region covered by an 1-th sector of SUᵢ, or may be represented as 0.

In step 215, the computing device 200 executes each agent for each secondary terminal, respectively, each agent may select an action in accordance with a policy by applying partial observation of each secondary terminal to a reinforcement learning-based actor-critic network model, and acquire a reward on the basis of a sensing result of a primary terminal on the basis of the selected action in the environment.

This is described in more detail.

It is impossible to fully understand the actual state of an environment due to the physical limitations of SUs. Accordingly, a single SU can sense only one channel and sector pair at each time step, so it can partially observe an environment state.

When ED is performed, an SU can estimate received signal power for a selected channel-sector pair.

In an embodiment of the present disclosure, partial observation of an agent is defined as

$${o}_{t}^{i} = [ {c}_{t}^{i} , {s}_{t}^{i} , {λ}_{t}^{i} ] .$$

In this case,

$${c}_{t}^{i} , {s}_{t}^{i} .$$

represents the indexes of selected channel and sector and

$${λ}_{t}^{i}$$

represents received signal power estimated by ED.

An action that is performed by each SU consists of a sensing threshold and the action (that is, the sensing threshold) can be used to determine whether a channel-sector pair is available. An action taken by SUᵢ at each time step t can be represented as

$${a}_{t}^{i} = {ϵ}_{t}^{i} ( {c}_{t}^{i} , {s}_{t}^{i} ) ,$$

in which

$${ϵ}_{t}^{i} ( {c}_{t}^{i} , {s}_{t}^{i} ) \geq 0.$$

That is, each agent may select an action according to a policy by applying partial observation of a secondary terminal (e.g., a specific channel-specific sector pair, estimated received signal power) to a reinforcement learning-based actor-critic network model. In this case, the policy, as defined in Equation 9, is to determine an optimal sensing threshold that can maximize a detection probability of correctly detecting presence of a PU and minimize an accumulated false alarm probability.

Each agent can calculate a reward by comparing whether a sensing result of a primary terminal is the same as an actual state by performing the action for partial observation in an environment.

According to an embodiment of the present disclosure, a reward function for each SU (i.e., each agent) can be designed in accordance with two cases that may occur. The first case is the case in which the sensing result of a channel-sector pair is the same as an actual state and the second case is the case in which the sensing result of a channel-sector pair is different from an actual state.

The reward function is required to induce each agent to select an action (i.e., a sensing threshold) that provides an accurate sensing result, so it can be designed as in Equation 10.

$${r}_{t}^{i} = \{ \begin{matrix}0 , & if \#1 happens , \\ - p & if \#2 happens ,\end{matrix} \qquad [ Equation 10 ]$$

wherein, p>0 represents a penalty score.

In order to solve Dec-POMDP, it is very important to know a transition probability that is an important component of a model, but it cannot be known. Accordingly, an embodiment of the present disclosure proposes a solution called multi-agent Decentralized CSS (DCSS).

In an embodiment of the present disclosure, a CTDE architecture in which a training step and an execution step are differently set is used.

It is assumed that, in the training step, all agents share their local knowledge with other agents so that they can learn from each other's experiences. In the training step, a critic network is trained in centralized manner and observations admitted by all agents can be provided.

On the other hand, in the execution step, after all agents obtain sufficient knowledge about an environment, they can determine an optimal action on the basis of only local observation using a trained actor network.

MA-DCSS adopts MADPPG, which is an extension of the DDPG algorithm, so each agent can learn its own policy by considering the policies of other agents in the environment. In particular, each agent is equipped with one actor network that is used to learn its own individual policy, and the actor network can use current observation as input and can return an action as output.

In step 220, the computing device 200 stores the partial observation, the selected action, the reward, and next observation of each agent in a replay buffer as experiences.

In step 225, the computing device 200 can update the actor-critic network model of each agent on the basis of the experiences stored in the replay buffer.

The actor-critic network model of each agent can be updated differently from each other in the training step and the execution step.

In the training step, each agent can train the actor-critic network model while sharing a policy and partial observation with other agents. Accordingly, in the training step, each agent can train the actor-critic network model by sharing the experiences of other agents in a centralized manner.

After sufficient training is finished, in the execution step, each agent may update the actor-critic network model on the basis of only its individual policy and local experience.

This is described in more detail.

An actor network may be updated using a policy gradient expressed as in Equation 11.

$${∇}_{{θ}^{i , μ}} J ( {μ}^{i} ) = {𝔼}_{B ∈ ℬ} [ {∇}_{θ} {μ}^{i} ( {a}_{t}^{i} \vert {o}_{t}^{i} ) {∇}_{{a}_{t}^{i}} {Q}^{i} ( {o}_{t} , {a}_{t} ) {\vert}_{{a}_{t}^{i} = {μ}^{i} ( {o}_{t}^{i} )} ] \qquad [ Equation 11 ]$$

wherein, B represents batch sample data, [symbol] represents an experience buffer,

$${a}_{t} = {[ {a}_{t}^{i} ]}_{i ∈ ℳ}$$

represents a common activity of all agents, and

$${o}_{t} = {[ {o}_{t}^{i} ]}_{i ∈ ℳ}$$

may include partial observation collected from all agents.

Further,

$${μ}^{i} ( {a}_{t}^{i} \vert {o}_{t}^{i} )$$

and Qⁱ(oₜ, aₜ) represent a deterministic policy and a centralized Q-value estimation functions of each agent.

In addition to an actor network, all agents have critic networks that are trained together in the training step. The critic network may use all observations and a common action of agents as input and can create a Q value as output. A loss function of the critic network may be expressed as in Equation 12.

$$ℒ ( {θ}^{i , Q} ) = {𝔼}_{B ∈ ℬ} [ {( y - {Q}^{i} ( {o}_{t} , {a}_{t} ) )}^{2} ] \qquad [ Equation 12 ]$$

wherein,

$$y = {r}_{t}^{i} + γ {Q}_{t}^{i}$$

is as shown in Equation 13.

$$y = {r}_{t}^{i} + γ {Q}_{tar}^{i} ( {o}_{t + 1} , {a}_{t + 1} ) {\vert}_{{a}_{t + 1}^{i} = {μ}_{tar}^{i} ( {o}_{t + 1}^{i} )} , \qquad [ Equation 13 ]$$

wherein, μₜₐᵣ and Qₜₐᵣ represent a target actor network and a target critic network, respectively.

In the training step, there is a problem in that an agent has to maintain balance between exploitation and exploration. Noise can be reflected to the output of an action so that sufficient exploration can be ensured and an agent can find an optimal point.

In an embodiment of the present disclosure, Ornstein-Uhlenbeck noise is used for action exploration and it can be defined as in Equation 14.

$${x}_{t} = {x}_{t - 1} + ϑ ( μ - {x}_{t - 1} ) dt + σ ( 0 , dt ) . \qquad [ Equation 14 ]$$

wherein, (θ, σ, μ) represents noise parameters.

An object of the system according to an embodiment of the present disclosure is to train all agents to learn an optimal sensing threshold that maximizes the sensing performance of a PU.

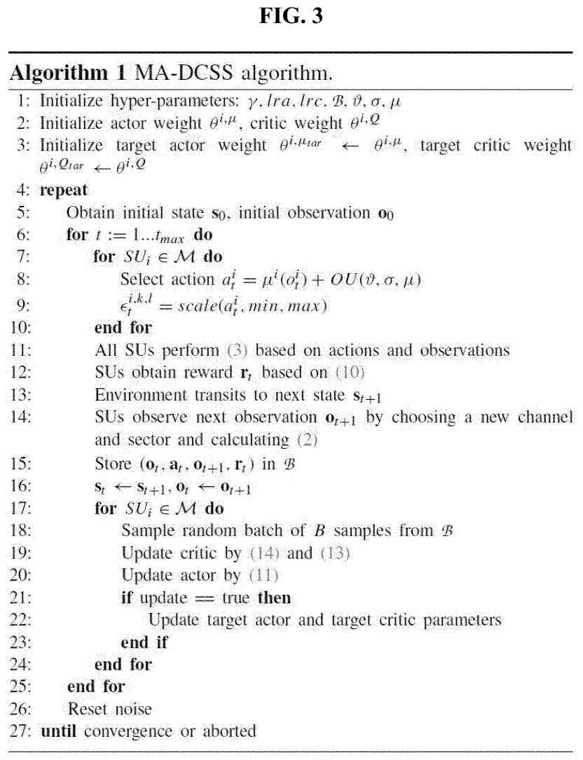

A pseudo code of MA-DCSS for the training step is as shown in FIG. 3.

In the training step, each agent has its own actor and critic network that perform forward and backward propagation to update a weight, in which the main operation is matrix multiplication. Accordingly, the computational complexity for a single episode in the training step may be expressed as O(B(IN+(D−2)N²+JN)).

In this case, D≥2 represents the number of layers and N represents the size of a hidden layer. Further, I and J represent the sizes of an input layer and an output layer, respectively.

According to an embodiment of the present disclosure, I=4M, M is a number representing the number of SUs, 4 represents the total dimension of observation and action spaces, and J is an output Q value, which is 1.

In the execution step, only forward propagation for an actor network is required, so the computational complexity is O((D−2)N²). That is, it is easy to see that the computational complexity is independent of the number of channels and sectors in both the training step and the execution step.

However, it can be seen that the computational complexity linearly increases in proportion to the number of SUs in the training step. Accordingly, the proposed algorithm can be said to have full scalability for the number of channels, the number of sectors, and the number of SUs.

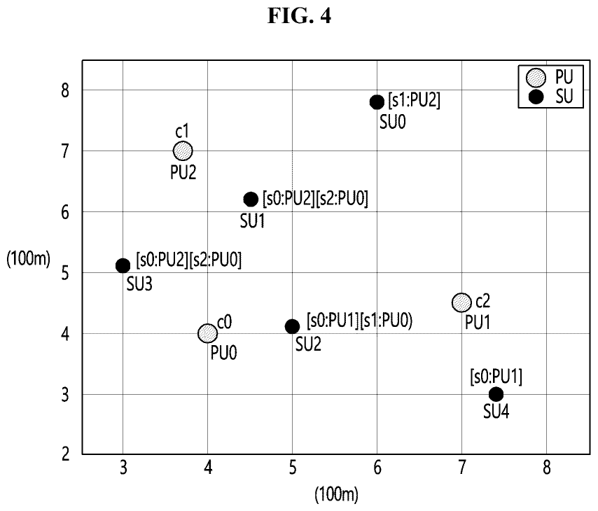

FIG. 4 is a diagram showing a system simulation environment according to an embodiment of the present disclosure. As shown in FIG. 4, a system environment in which the number of PUs is 3 and the number of SUs is 5 is assumed.

In an embodiment of the present disclosure, it is assumed that each SU has three sectors for sensing and communication and can select a directional beam in one of the sectors at each time point t.

Further, it is assumed that all channels (e.g., c₀, c₁, c₂) are locally or partially assigned to PUs and some PUs are positioned in the coverage of each of sectors (e.g., [symbol] ₀, [symbol] ₁, [symbol] ₂) of SUS.

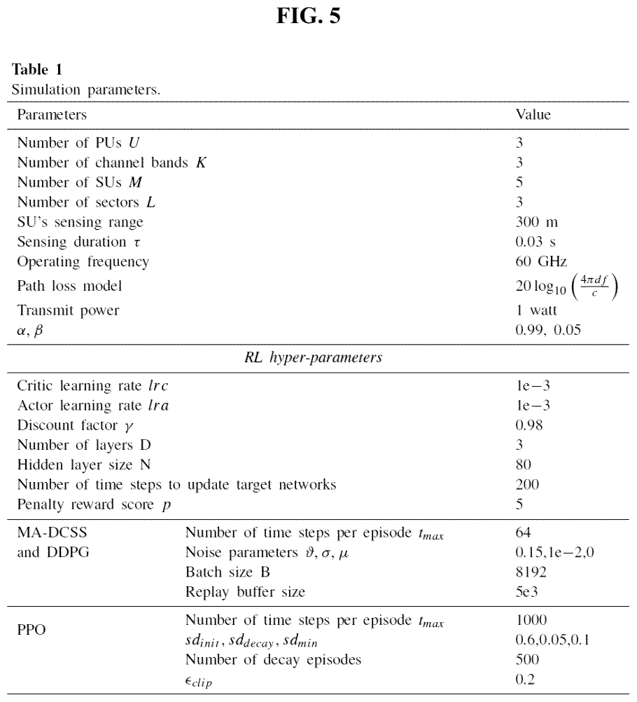

In an embodiment of the present disclosure, simulation was performed 10 times using the positions of random SUs and PUs and the results were averaged. The simulation parameters are as shown in FIG. 5.

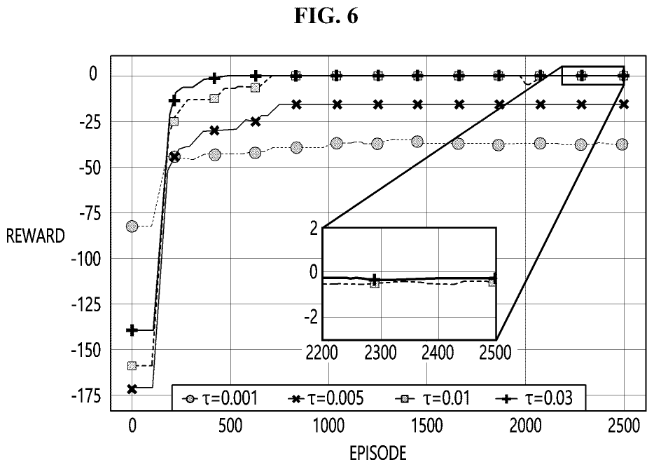

FIG. 6 is a diagram showing convergence results at different sensing times. FIG. 6 is a diagram showing convergence of a multi-agent reinforcement learning-based optimal energy sensing threshold control method in distributed cognitive radio networks according to an embodiment of the present disclosure at various sensing times from 0.001 seconds to 0.03 seconds. As shown in FIG. 6, it can be seen that the longer the sensing time, the larger the reward that is obtained by an agent, but the more stably the reward converges.

This positive correlation is based on the fact that, the longer the sensing period, the more comprehensive information the agent can collect about detected channels and sectors. Further, it is necessary to note that once a specific sensing threshold is exceeded, the influence on the overall performance by additional extension of the sensing time becomes less significant.

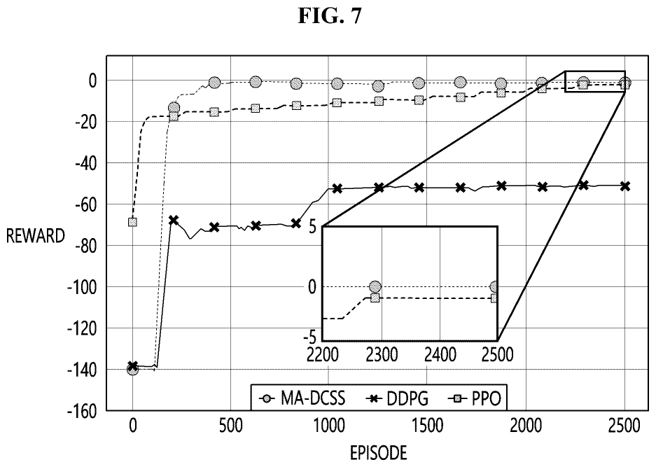

FIG. 7 is a diagram comparing convergence results of energy sensing threshold control method according to the related art and an embodiment of the present disclosure.

As shown in FIG. 7, it can be seen that the multi-agent reinforcement learning-based optimal energy sensing threshold control method in distributed cognitive radio networks according to an embodiment of the present disclosure converges quickly in comparison to the related art.

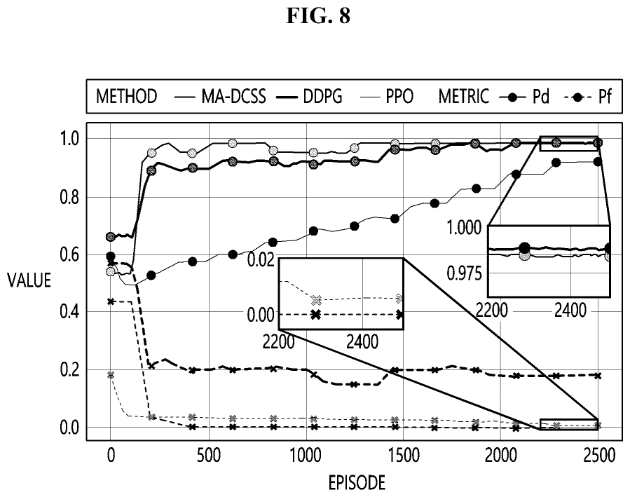

FIG. 8 is a diagram showing the result of comparing detection probabilities and false alarm probabilities according to the related art and an embodiment of the present disclosure. The multi-agent reinforcement learning-based optimal energy sensing threshold control method in distributed cognitive radio networks according to an embodiment of the present disclosure provided a detection probability of about P_{d}⇄0.99 and a wrong alarm probability of P_{f}⇄0 after about 500 episodes.

On the other hand, a RPO-based RL algorithm of the related art provided a detection probability of about P_{d}⇄0.93 and a wrong alarm probability of P_{f}⇄0.007 after about 2300 episodes, and a DDPG-based RL algorithm showed very excellent performance in terms of detection probability and achieved P_{d}⇄1.0 However, this calculated the worst false alarm probability around P_{f}⇄0.2.

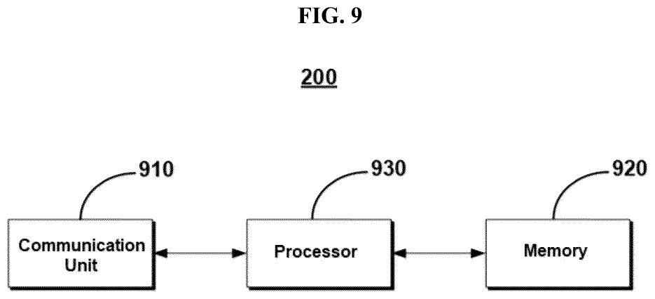

FIG. 9 is a block diagram schematically showing the internal configuration of a computing device according to an embodiment of the present disclosure. In this case, the computing device 200 may be a server or an SU.

Referring to FIG. 9, the computing device 200 according to an embodiment of the present disclosure includes a communication unit 910, a memory 920, and a processor 930.

The communication unit 910 is a component for transmitting and receiving data from and to other devices through a communication network.

The memory 920 stores at least one command for performing the multi-agent reinforcement learning-based optimal energy sensing threshold control method in distributed cognitive radio networks according to an embodiment of the present disclosure.

The processor 930 is a component for controlling internal components (e.g., the communication unit 910, the memory 920, and the like) of the computing device 200 according to an embodiment of the present disclosure.

Further, the processor 930 can execute the commands stored in the memory 920. Commands executed by the processor 930 can perform a series of processes of constructing a state space for a network environment including a plurality of primary terminals and a plurality of secondary terminals, executing each agent for each secondary terminal, respectively, selecting an action in accordance with a policy by applying partial observation of each secondary terminal to a reinforcement learning-based actor-critic network model by means of each agent, calculating a reward on the basis of a sensing result of the primary terminals on the basis of the selected action in the environment, storing the partial observation, the selected action, the reward, and next observation of each agent into a replay buffer as experiences, and updating the actor-critic network model of each agent on the basis of the experiences stored in the replay buffer. This is the same as that described with reference to FIG. 2, so repeated description is omitted.

The device and method according to the embodiments of the present disclosure may be implemented in a program that can be executed by various computers and may be recorded on computer-readable media. The computer-readable media may include program commands, data files, and data structures individually or in combinations thereof. The program commands that are recorded on a computer-readable media may be those specifically designed and configured for the present disclosure or may be those known to those engaged in the computer software field and thus available. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter, etc.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A multi-agent reinforcement learning-based optimal energy sensing threshold control method in distributed cognitive radio networks, comprising the steps of:
(a) constructing a state space for a network environment including a plurality of primary terminals and a plurality of secondary terminals, the state space including each state about whether the primary terminals are occupied;
(b) selecting an action in accordance with a policy by applying partial observation of each secondary terminal to a reinforcement learning-based actor-critic network model by means of an agent, and calculating a reward on the basis of a sensing result of the primary terminals on the basis of the selected action in the network environment, the action being a sensing threshold;
(c) storing the partial observation, the selected action, the reward, and next observation into a replay buffer as experiences; and
(d) updating the actor-critic network model on the basis of the experiences stored in the replay buffer.

2. The multi-agent reinforcement learning-based optimal energy sensing threshold control method of claim 1, wherein the replay buffer also stores experiences of other agents in a training step, and, in the step (d), each agent trains the actor-critic network model of each agent in a centralized manner by sharing the experiences of other agents; and
the step (d), in an execution step, each agent updates the actor-critic network model of each agent using only a local experience of each agent.

3. The multi-agent reinforcement learning-based optimal energy sensing threshold control method of claim 1, wherein the policy is to determine a sensing threshold that maximizes a probability of correctly detecting the primary terminals and minimizes an accumulated false alarm probability up to a time step t.

4. The multi-agent reinforcement learning-based optimal energy sensing threshold control method of claim 1, wherein the policy is formulated into the following equation,
$${max}_{{ϵ}_{t} = [ {ϵ}_{t}^{i} ( {c}_{t}^{i} , {s}_{t}^{i} ) ]} {\sum }_{t \geq 0} {\sum }_{i = 1}^{M} {P}_{d}^{i} ( t ) + ( 1 - {P}_{f}^{i} ( t ) )$$
$$s . t . {ϵ}_{t}^{i} ( {c}_{t}^{i} , {s}_{t}^{i} ) \geq 0 ,$$
$$∀ {c}_{t}^{i} ∈ [ 0 , … , K - 1 ] , {s}_{t}^{i} ∈ [ 0 , … , L - 1 ]$$
wherein
$${ϵ}_{t}^{i} ( {c}_{t}^{i} , {s}_{t}^{i} )$$
represents a detection threshold for specific channel
$${c}_{t}^{i}$$
and sector
$${s}_{t}^{i}$$
at a time step t selected by an i-th secondary terminal,
$${c}_{t}^{i}$$
represents an orthogonal channel owned by a primary terminal,
$${s}_{t}^{i}$$
represents a sector of the i-th secondary terminal, K represents the number of orthogonal channels, L represents the number of sectors,
$${P}_{d}^{i} ( t )$$
represents an accumulated detection probability of a primary terminal up to the time step t,
$${P}_{f}^{i} ( t )$$
represents an accumulated false alarm probability up to the time step t, and M represents an index of a secondary terminal.

5. The multi-agent reinforcement learning-based optimal energy sensing threshold control method of claim 1, wherein the reward gives zero (0) when a detection result of a primary terminal based on the selected action in the network environment and an actual state are the same, and gives a penalty when the detection result of the primary terminal based on the selected action in the network environment and the actual state are different; and
the actual state is any one of channel occupation or non-occupation of the primary channel.

6. A non-transitory computer-readable recording medium storing program codes for performing the method of claim 1.

7. A computing device, comprising:
a memory storing at least one command; and
a processor executing commands stored in the memory,
wherein the commands executed by the processor respectively perform:
(a) constructing a state space for a network environment including a plurality of primary terminals and a plurality of secondary terminals, the state space including each state about whether the primary terminals are occupied;
(b) executing each agent for each secondary terminal, selecting an action in accordance with a policy by applying partial observation of each secondary terminal to a reinforcement learning-based actor-critic network model by means of an agent, and calculating a reward on the basis of a sensing result of the primary terminals on the basis of the selected action in the network environment, the action being a sensing threshold;
(c) storing the partial observation, the selected action, the reward, and next observation of each agent into a replay buffer as experiences; and
(d) updating the actor-critic network model on the basis of the experiences stored in the replay buffer.

8. The computing device of claim 7, wherein the replay buffer also stores experiences of other agents in a training step, and, in the step (d), each agent trains the actor-critic network model of each agent in a centralized manner by sharing the experiences of other agents; and
the step (d), in an execution step, each agent updates the actor-critic network model of each agent using only a local experience of each agent.

9. The computing device of claim 7, wherein the policy is to determine a sensing threshold that maximizes a probability of correctly detecting the primary terminals and minimizes an accumulated false alarm probability up to a time step t.

10. The computing device of claim 7, wherein the policy is formulated into the following equation,
$$\begin{matrix}max \\ {ϵ}_{t} = [ {ϵ}_{t}^{i} ( {c}_{t}^{i} , {s}_{t}^{i} ) ]\end{matrix} {\sum }_{t \geq 0}^{} {\sum }_{i = 1}^{M} {P}_{d}^{i} ( t ) + ( 1 - {P}_{f}^{i} ( t ) )$$
$$s . t . {ϵ}_{t}^{i} ( {c}_{t}^{i} , {s}_{t}^{i} ) \geq 0 ,$$
$$∀ {c}_{t}^{i} ∈ [ 0 , ... , K - 1 ] , {s}_{t}^{i} ∈ [ 0 , ... , L - 1 ]$$
where
$${ϵ}_{t}^{i} ( {c}_{t}^{i} , {s}_{t}^{i} )$$
represents a detection threshold for specific channel
$${c}_{t}^{i}$$
and sector
$${s}_{t}^{i}$$
at a time step t selected by an i-th secondary terminal,
$${c}_{t}^{i}$$
represents an orthogonal channel owned by a primary terminal,
$${s}_{t}^{i}$$
represents a sector of the i-th secondary terminal, K represents the number of orthogonal channels, L represents the number of sectors,
$${P}_{d}^{i} ( t )$$
represents an accumulated detection probability of a primary terminal up to the time step t,
$${P}_{f}^{i} ( t )$$
represents an accumulated false alarm probability up to the time step t, and M represents an index of a secondary terminal.

11. The computing device of claim 7, wherein the reward gives zero (0) when a detection result of a primary terminal based on the selected action in the network environment and an actual state are the same, and gives a penalty when the detection result of the primary terminal based on the selected action in the network environment and the actual state are different; and
the actual state is any one of channel occupation or non-occupation of the primary channel.

12. A system, comprising:
a plurality of primary terminals; and
a plurality of secondary terminals,
wherein the plurality of secondary terminals each includes:
constructing a state space for a network environment including a plurality of primary terminals and a plurality of secondary terminals, the state space including each state about whether the primary terminals are occupied;
selecting an action in accordance with a policy by applying partial observation of each secondary terminal to a reinforcement learning-based actor-critic network model by means of an agent, and calculating a reward on the basis of a sensing result of the primary terminals on the basis of the selected action in the network environment, the action being a sensing threshold;
storing the partial observation, the selected action, the reward, and next observation into a replay buffer as experiences; and
updating the actor-critic network model on the basis of the experiences stored in the replay buffer.
